(19) United States
(12) Patent Application Publication
(10) Pub. No.: US 2011/0129787 A1
(43) Pub. Date: Jun. 2, 2011

(54) DENTAL TRAY AND METHOD

(76) Inventor: Daniel Henry Darnell, Cullman, AL (US)

(21) Appl. No.: 12/956,856

(22) Filed: Nov. 30, 2010

Related U.S. Application Data
(60) Provisional application No. 61/265,197, filed on Nov. 30, 2009.

(51) Int. Cl. A61C 19/06; A61C 9/00

(52) U.S. Cl. 433/25; 433/214; 433/215

(57) ABSTRACT

A method for creating a custom dental tray is made by filling a dental tray with an elastomer material, obtaining a first impression of a patient's teeth in the elastomer material by pressing the elastomer-filled dental tray against the patient's teeth, heating a polymer sheeting, and placing the heated polymer sheeting over the first impression in the elastomer-filled dental tray. In addition, the custom dental tray is made by obtaining a second impression of the patient's teeth in the polymer sheeting by pressing the elastomer-filled dental tray having the first impression and the heated sheeting over the patient's teeth and removing the polymer sheeting from the elastomer-filled dental tray.

### CROSS REFERENCE TO RELATED APPLICATION

This application claims priority to U.S. Provisional Application Ser. No. 61/265,197 entitled “Dental Tray and Method” and filed on Nov. 30, 2009, which is incorporated herein by reference.

### BACKGROUND

In dentistry, impressions are oftentimes made of a patient's teeth in order to create custom fit dental trays. Custom fit dental trays are used in a variety of ways. For example, custom fit dental trays are used for teeth bleaching, treatment of periodontal disease, desensitizing teeth, remineralizing teeth, treatment of tooth decalcification, breath freshening, root caries treatment, among others. Solutions of various chemical compositions are placed into the custom formed mouth tray and the tray is placed over the teeth of the user to allow such chemicals to have intimate contact with dental structures undiluted by oral fluids.

To make an impression of a patient's teeth, polyvinyl siloxane (PVS), a silicone elastomer, is poured into a cup of a dental impression tray. The dental impression tray is then pressed onto the patient's teeth, causing the PVS to ooze through a plurality of holes in the dental impression tray and an impression of the patient's teeth is made in the PVS as the residual PVS escapes.

The cup and PVS are then removed from the patient's teeth, and after some time the impression made of the patient's teeth in the PVC hardens. This hardened impression can then be used in various ways, including making dental trays.

To create custom fit dental trays from the hardened impressions, a technique using a vacuuforming machine is used to create the custom fit dental trays from a model made from the impressions. This process is time consuming and may not result in a custom fit dental tray having a uniform thickness.

Custom fit dental trays dental trays may also be made of ethylene-vinyl acetate (EVA) material and are created using a boil-and-bite method. Such boil-and-bite type trays are used in sports to protect teeth; however, the material that is used is very thick thereby limiting their utility.

### DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the figures.

FIG. 1 is a perspective view of an exemplary dental tray in accordance with an embodiment of the present disclosure.

FIG. 2 depicts polyvinyl siloxane (PVS) in the dental tray depicted in FIG. 1.

FIG. 3 depicts exemplary teeth impressions made in the PVS in the dental tray depicted in FIG. 1.

FIG. 4 depicts trimming of the excess PVS of FIG. 4 in accordance with an embodiment of the present disclosure.

FIG. 5 depicts a standard heating pot in accordance with an embodiment of the present disclosure.

FIG. 6 depicts an exemplary sheeting of ethyl vinyl acetate (EVA) being heated in the heating pot of FIG. 6.

FIG. 7 depicts the sheeting of EVA being placed over the PVS-filled dental tray of FIG. 3.

FIG. 8 depicts the insertion of the PVS-filled dental tray having the exemplary sheeting thereon as depicted in FIG. 8 inserted into the mouth of a patient.

FIG. 9 depicts the sheeting of EVA and the PVS after an impression is made as indicated in FIG. 9.

FIG. 10 depicts the sheeting of EVA after its removal from the PVS as depicted in FIG. 10.

FIG. 11 depicts the cutting away of excess sheeting in order to obtain an impression made in the exemplary sheeting of EVA.

FIG. 12 depicts an exemplary dental tray in accordance with an embodiment of the present disclosure.

FIG. 13 depicts another view of the dental tray of FIG. 13.

### DETAILED DESCRIPTION

The present disclosure relates to a method of making a custom fit dental tray. In particular, a sheeting of polymer, such as ethyl vinyl acetate (EVA), is placed over a polyvinyl siloxane (PVS) filled dental tray having an impression of a patient's teeth therein.

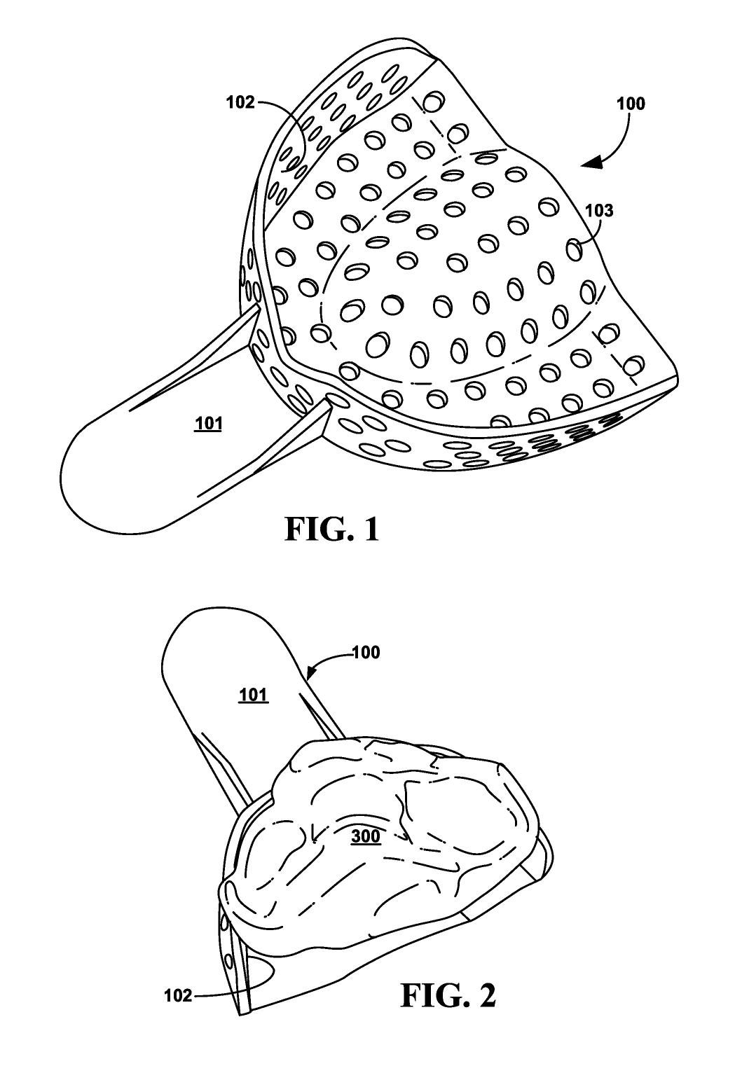

FIG. 1 depicts an exemplary dental tray 100 in accordance with an embodiment of the present disclosure. The dental tray 100 comprises a handle 101 and a cup portion 102. The cup portion 102 comprises a plurality of openings 103.

During normal use, polyvinyl siloxane (PVS) (not shown) is placed in the cup portion 102, and the cup portion 102 is placed in a patient's mouth (not shown) over the patient's teeth. Note that PVS is an exemplary material that may fill the dental tray. Other elastomer materials may be used in other embodiments of the present disclosure. As the PVS-filled cup portion 102 is pressed against the patient's teeth, excess PVS oozes through the openings 103, and an impression of the patient's teeth is made in the PVS, as described further herein

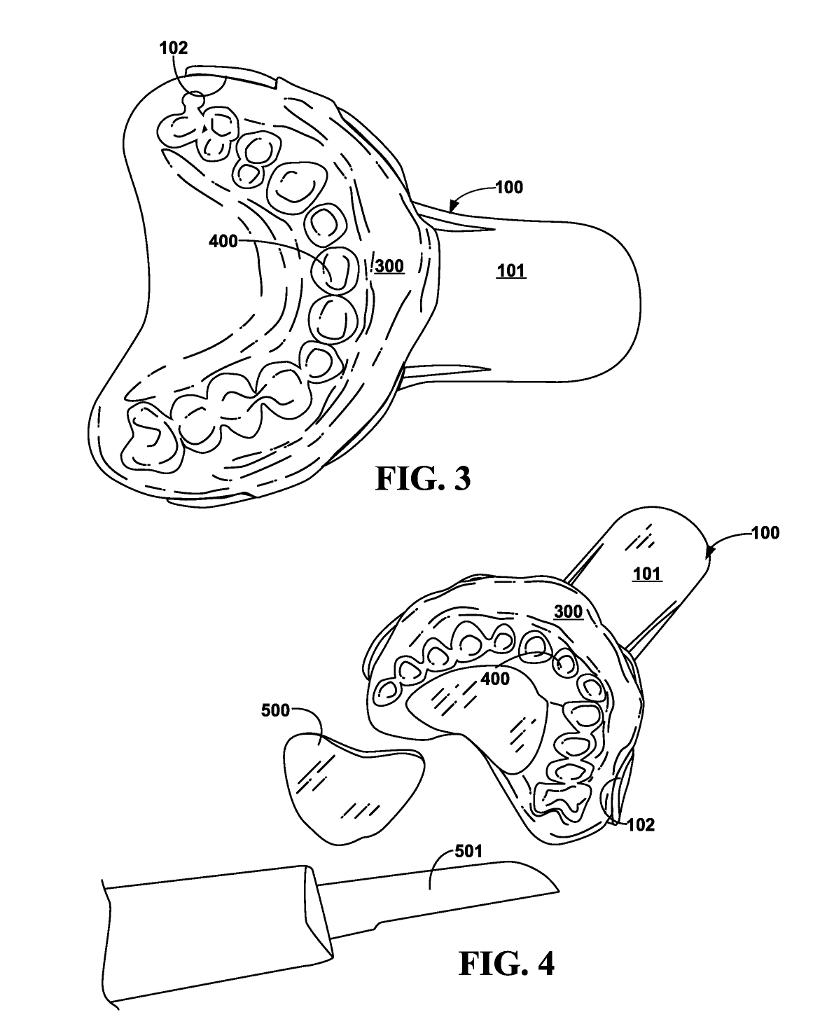

FIG. 2 depicts the exemplary dental tray 100 with the cup portion 102 filled with PVS 300. A user (not shown) grasps the handle 101 and places the cup portion 102 filled with the PVS 300 into a patient's mouth (not shown). With reference to FIG. 3, using the handle 101, the user presses the PVS-filled cup 102 against the patient's teeth, and an impression 400 of the patient's teeth is formed in the PVS 300. Note that the present disclosure is described wherein a patient's upper teeth, or those teeth that are in the maxilla, are illustrated. However, the same process in accordance with an embodiment of the present disclosure may be applied to the lower teeth in the mandible.

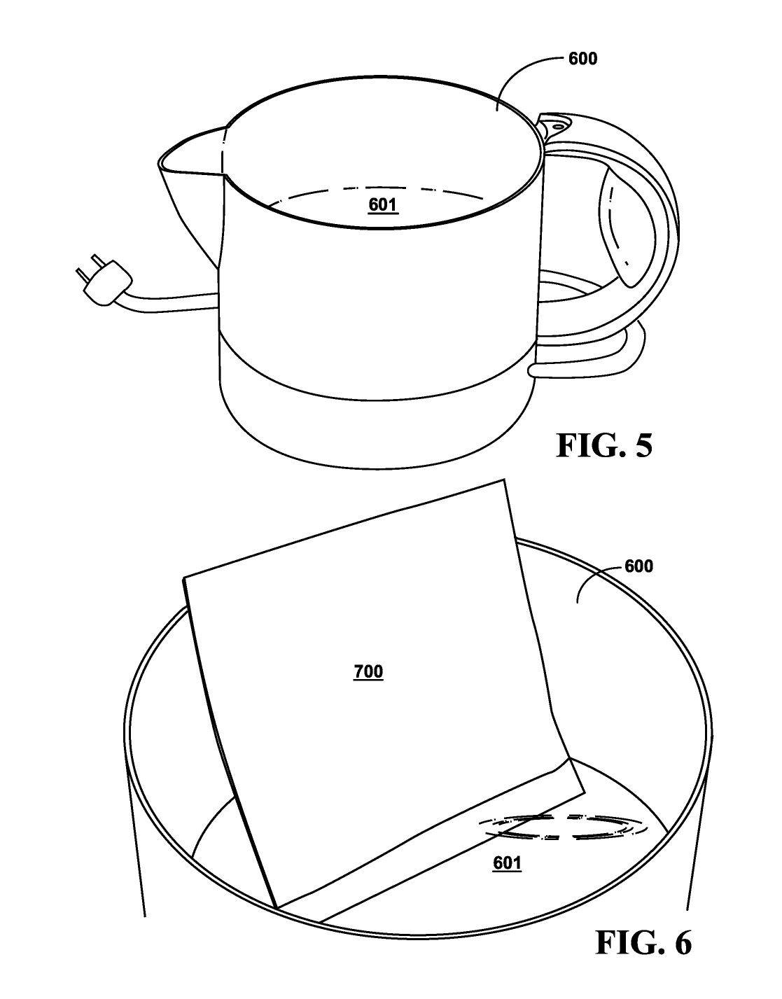

FIG. 4 depicts the impression 400 in the PVS 300 while the PVS 300 is still situated within the cup 102 of the dental tray 100. If there is excess PVS 300, the user (not shown) can use a cutting instrument 501 to trim the excess PVS 300 from the impression 400. In FIG. 5, the cutting instrument 501, such as a knife, is used to trim away a portion 500 from the PVS 300 made by the roof of the patient's mouth (not shown). Trimming away of excess PVS 300 makes the impression 400 more suitable for creating an ethyl vinyl acetate (EVA) impression, as described further herein.

FIG. 5 depicts a standard water heating pot 600. The pot 600 contains water 601. The pot 600 heats the water 601 contained within the pot to a desired temperature. Notably, the desired temperature is that temperature that is the melting temperature of the EVA material (not shown), or any other plastic material suitable to make a dental tray.

FIG. 6 depicts a sheeting 700 of EVA. Note that EVA sheeting 700 is shown, however any type of moldable plastic may be used in the present disclosure. The sheeting 700 is placed within the water 601 of the heating pot 600. When placed in the water 601, the sheeting 700 melts to a point that the sheeting 700 is deformable.

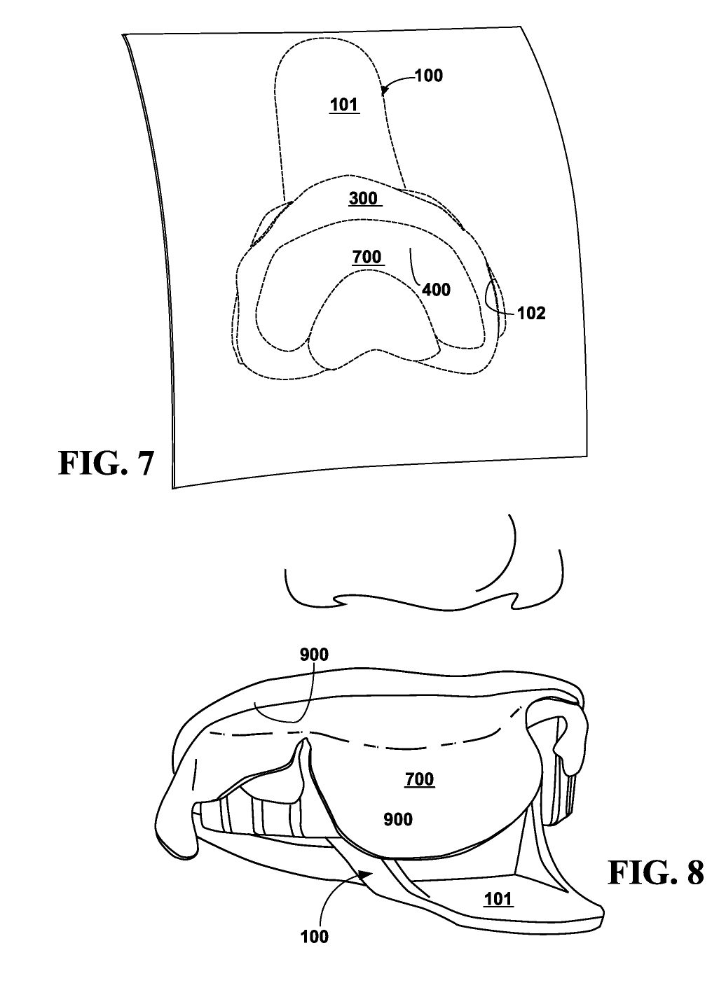

With reference to FIG. 7, the heated sheeting 700 is placed over the dental tray cup 102 having the impression 400 formed therein in the PVS 300. The sheeting 700 and the dental tray 100 having the sheeting 700 thereon is then placed in a patient's mouth 900, as shown with reference to FIG. 8. The sheeting 700 covering the impression 400 (FIG. 8) is then pressed against the patient's teeth (not shown) within the patient's mouth 900.

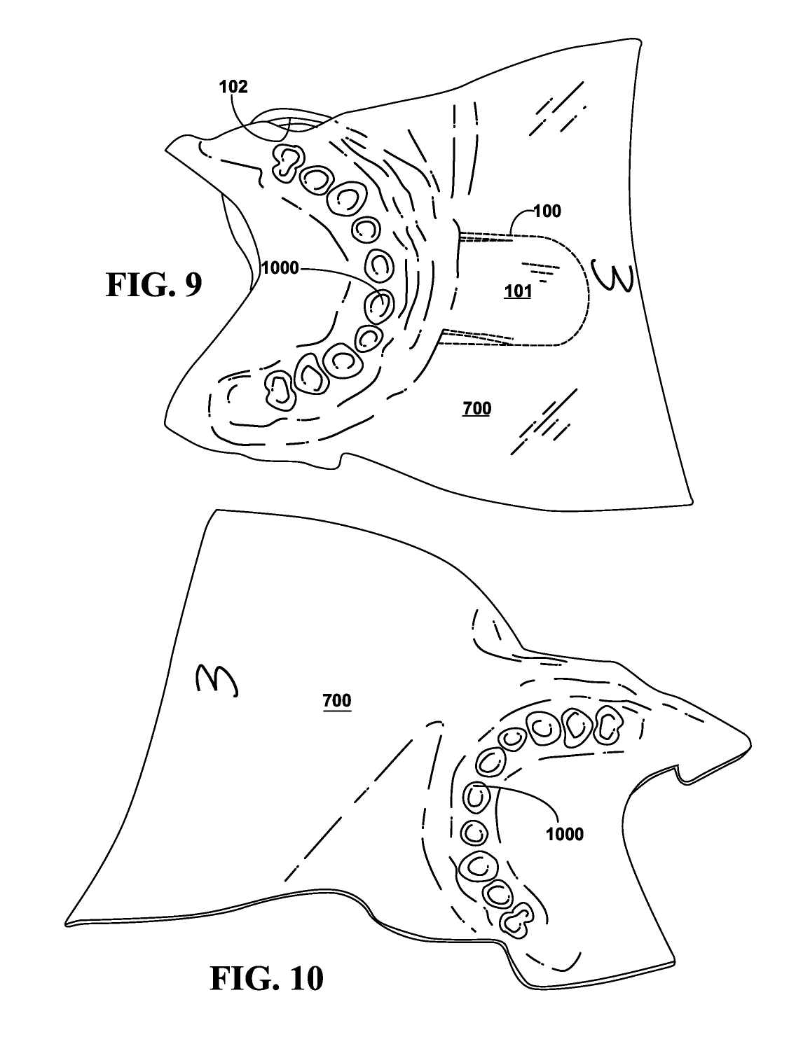

FIG. 9 depicts the dental tray 100 and the EVA sheeting 700 once it has been removed from the patient's mouth 900 (FIG. 9). Notably, after removal there is an impression 1000 made in the sheeting 700 that is substantially similar to the impression 400 (FIG. 4) that is made in the PVS 300 (FIG. 4).

FIG. 10 depicts the sheeting 700 once it has been removed from the dental tray 100 (FIG. 10) and the PVS 300 (FIG. 5). Notably, the sheeting 1000 has the impression 1000 substantially similar to the impression 400 (FIG. 4).

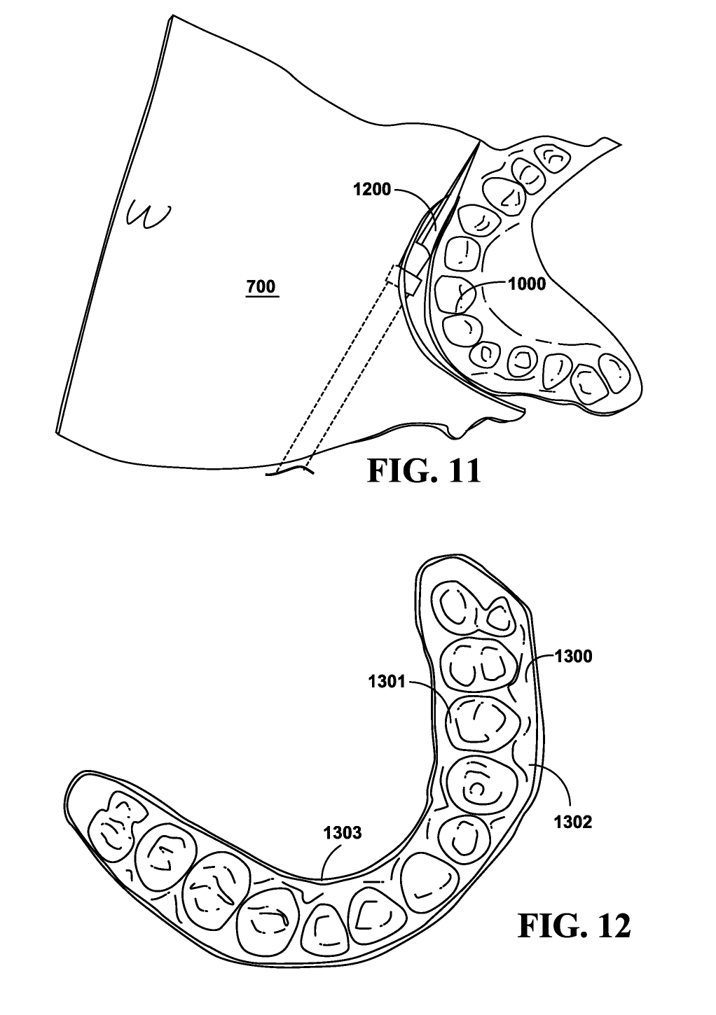

Once the impression 1000 is made in the sheeting 700, it may be desirable to remove any excess EVA. Thus, FIG. 11 depicts a cutting instrument 1200, such as a knife or scalpel, which is used to remove excess of the EVA sheeting 700 from the impression 1000. Note that the sheeting 700 may be trimmed to any desired height from the level above the gingival margin of the teeth (not shown) and the gums (not shown), to any desired level on the teeth.

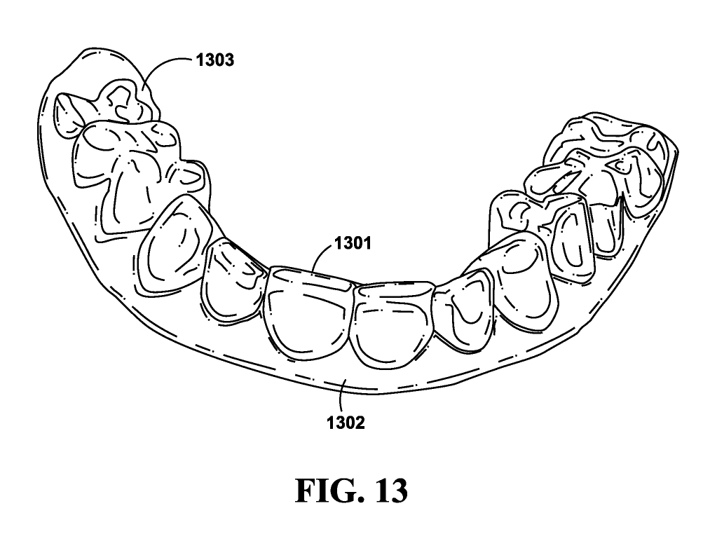

Removal of the excess from the EVA sheeting 700 forms the dental tray 1300 depicted in FIGS. 12 and 13. The dental tray 1300 can be used as a dental substance delivery device. In this regard, the dental tray 1300 can be filled with products (not shown) to treat the dentition of the patient (not shown). Notably, the dental tray 1300 may be filled with peroxide (not shown) for bleaching teeth, fluoride (not shown) for hardening, desensitizing and remineralizing teeth. Additionally, the dental tray 1300 may be filled with potassium nitrate compounds, breath freshening compounds, periodontal medicaments, calcium carbonate products, or any product that can be used to treat the teeth and gums of the patient.

The dental tray 1300 has a plurality of teeth impressions 1301. In addition to the plurality of teeth impressions the dental tray 1300 has an outward flange 1302 that extends from the plurality of teeth impressions 1301 over the outside gum of a patient's mouth (not shown). In addition, the dental tray 1300 has an inward flange 1303 that extends from the plurality of teeth impressions 1301 over the inside gum of the patient's mouth.

1. A method, comprising:
filling a dental tray with as elastomer material;
obtaining a first impression of a patient's teeth in the elastomer material by pressing the elastomer-filled dental tray against the patient's teeth;
heating a polymer sheeting;
placing the heated polymer sheeting over the first impression in the elastomer-filled dental tray;
obtaining a second impression of the patient's teeth in the polymer sheeting by pressing the elastomer-filled dental tray having the first impression and the heated sheeting over the patient's teeth; and
removing the polymer sheeting from the elastomer-filled dental tray.

2. The method of claim 1, further comprising trimming excess polymer sheeting from the second impression to form a custom fit dental tray.

3. The method of claim 2, further comprising filling the custom fit dental tray with material for treating the patient's teeth.

4. The method of claim 3, further comprising inserting the material-filled custom dental tray over the patient's teeth.

5. The product made by the method of claim 1.

6. A dental tray, comprising:
a plurality of teeth impressions;
an outward flange that extends upward from the plurality of teeth impressions; and
an inward flange that extends upward from the plurality of teeth impressions.

7. The dental tray of claim 6 made of a polymer material.

8. The dental tray of claim 7, wherein the polymer material is ethylene-vinyl acetate.
